(19) United States
(12) Patent Application Publication
(10) Pub. No.: US 2006/0155560 A1
(43) Pub. Date: Jul. 13, 2006

(54) Semiconductor market development and resource management method

(76) Inventor: Pien Chien, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/033,726

(22) Filed: Jan. 13, 2005

(51) Int. Cl. G06Q 99/00; G07G 1/00; G06F 17/30

(52) U.S. Cl. 705/1; 705/10

(57) ABSTRACT

A semiconductor market development and resource management method compriseing collecting at least one client's data regarding a semiconductor industry. The data is collected and a client management database is established. The collected data in the client management database cooperates with at least one assessment condition to analyze and convert the data into knowledge capable of supporting the enterprise management.

### BACKGROUND OF THE INVENTION

1. Field of the Invention

The present invention relates to a market development and resource management method, and more particularly, to a semiconductor market development and resource management method.

2. Description of the Prior Art

In recent years, advanced semiconductor industries have served to intensify competition and hasten the pace in which industries need to respond to key events, such as the design house, the wafer material industry, the mask industry, the semiconductor manufacturing, and so on.

The semiconductor process is a very complex technology. The required cost is very high. Although the semiconductor industry requires a large investment and is subject to high risk, it also obtains a good profit. Therefore, many are very active in entering this industry. However, the enterprise faces an important issue of how to effectively reduce the cost and increase their competitiveness.

The concept of strategic alliance or common investment has become a common tendency, which reduces the cost and increases the competitiveness by supporting the relative enterprise. The successful co-operation can bring a large profit. However, the wrong strategy will bring about crisis. The enterprise faces a challenge of preventing the wrong strategy.

In view of this, the present invention provides a semiconductor market development and resource management method which conducts Enterprise Resource Planning (ERP) and Customer Relationship Management (CRM) by collecting the client's data regarding the semiconductor industry and establishing a client management database, in order to provide a reference for the proprietor while selecting the co-operative target and determining the strategy.

### SUMMARY OF THE INVENTION

The present invention provides a semiconductor market development and resource management method, which is used by collecting and analyzing industry data to provide a reference for market development and resource management.

The present invention also provides a method of effectively selecting the co-operative target to increase the competitiveness, which is used by collecting industry data and analyzing the database to provide information to the enterprise for assessing the optimum co-operative target.

The present invention also provides a method of effectively converting the data into knowledge, which is used by collecting the data regarding the semiconductor industry and analyzing based on different assessment conditions, in order to convert the data into knowledge capable of supporting the enterprise management.

According to a preferred embodiment of the present invention, a semiconductor market development and resource management method is provided. The data is collected and a client management database is established. The collected data in the client management database cooperates with at least one assessment condition to analyze and convert the data into knowledge capable of supporting the enterprise management.

These and other objectives of the present invention will become obvious to those of ordinary skill in the art after reading the following detailed description of the preferred embodiment.

It is to be understood that both the foregoing general description and the following detailed description are exemplary, and are intended to provide further explanation of the invention as claimed.

### BRIEF DESCRIPTION OF THE DRAWINGS

The accompanying drawing is included to provide a further understanding of the invention, and are incorporated in and constitute a part of this specification. The drawing illustrates one embodiment of the invention and, together with the description, serve to explain the principles of the invention. In the drawing,

FIG. 1 is a flow chart of performing a semiconductor market development and resource management method according to an embodiment of the present invention.

### DETAILED DESCRIPTION OF THE PREFERRED EMBODIMENTS

The present invention provides a semiconductor market development and resource management method, which conducts Enterprise Resource Planning (ERP) and Customer Relationship Management (CRM) by collecting the client's data regarding the semiconductor industry and establishing a client management database, in order to provide a reference for the proprietor while selecting a co-operative target and determining a strategy.

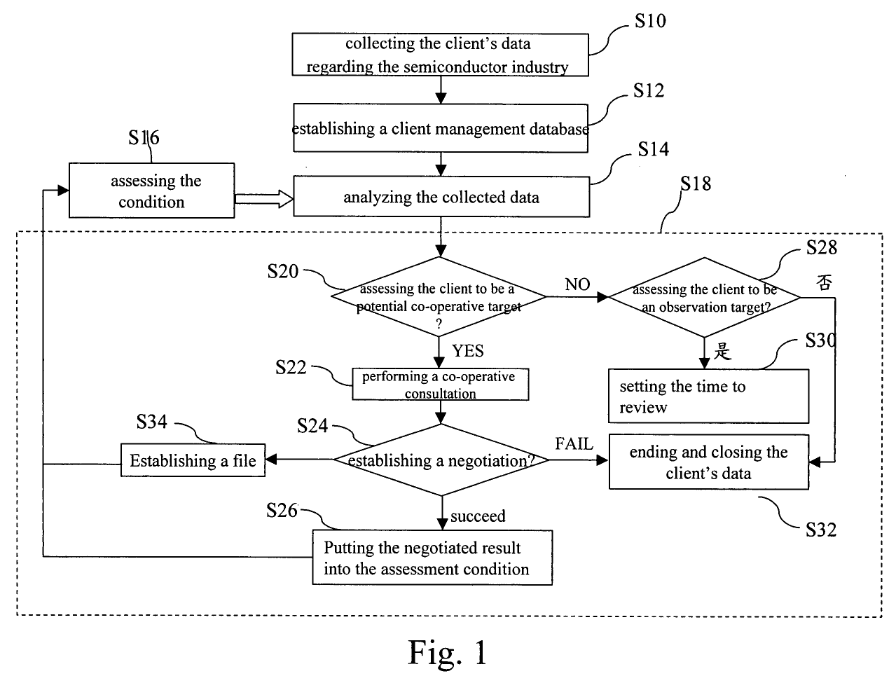

Refer to FIG. 1, at the beginning, as shown in step S10, at least one client's data is collected regarding a semiconductor industry, wherein the client's data is searched by a stock exchange committee and a company which handles a commercial registration in a local government to obtain the information of a sunrise industry. The collected data not only includes the enterprise's basic information, such as enterprise scope, enterprise staff, the enterprise location, business information, R&D status, enterprise reputation, enterprise vision and so on, but also web site information. Next, step S12 is performed. A client management database is established depending on the collected data. As shown in steps S14 and S16, the collected data in the client management database cooperating to analyze an assessment condition, such as a technology assessment, a market assessment, product analysis, a timely analysis, a regional economy assessment, a national policy assessment, a customers SWOT analysis and so on, in order to classify the client's data in the client management database. Then step S18 is performed. An interaction strategy of the client is drafted depending on the analyzed result.

In drafting the interaction strategy, step S18 comprises step S20 and step S34. As show in step S20, the client is classified to be a potential co-operative target and an observation target. Step S22 is performed if the client is classified to be a potential co-operative target. Step S28 is performed if the client is classified to be an observation target.

When the classified result is a potential co-operative target as shown in step S20, step S22 is performed to establish a co-operative consultation and a negotiation. Step S26 is performed if the negotiation is successful. Co-operative consultation is performed and a negotiated result is put into the assessment condition to provide a reference of the analyzed result. Step S22 is performed if the negotiation fails. The co-operative consultation is ended and closes the client's data. Step 34 is performed whether the negotiation in step S24 succeeded or failed. A file of the negotiated data is established and put into the assessment condition to provide a reference.

If the classified result is an observation target, step S28 is performed. Step S28 determines whether the client is continuously observed or not. A time to review is set if yes. Step S32 is performed if no. The co-operative consultation is ended and the client's data is closed.

The present invention provides a semiconductor market development and resource management method, by collecting and analyzing industry data to convert into intangible assets with economical enterprise results. It not only provides market information for the enterprise, but also increases competitive advantages.

The embodiment above is only intended to illustrate the present invention; it does not, however, to limit the present invention to the specific embodiment. Accordingly, various modifications and changes may be made without departing from the spirit and scope of the present invention as described in the following claims.

What is claimed is:

1. A method for semiconductor market development and resource management, comprising:
collecting at least one client's data regarding a semiconductor industry;
establishing a client management database depending on the collected data;
analyzing the collected data in the client management database cooperating with at least one assessment condition; and
drafting an interaction strategy of the client depending on the analyzed result, and putting a message regarding the interaction strategy into the assessment condition to provide an analysis correction for the interaction strategy.

2. The method for semiconductor market development and resource management of claim 1, wherein the client is a sunrise industry in the semiconductor industry.

3. The method for semiconductor market development and resource management of claim 1, wherein collecting at least one client's data is researched by a stock exchange committee and a company which handles a commercial registration in a local government.

4. The method for semiconductor market development and resource management of claim 1, wherein the client management database further comprises web site data of the client.

5. The method for semiconductor market development and resource management of claim 1, wherein the assessment condition provides a reference of the analyzed result for a proprietor.

6. The method for semiconductor market development and resource management of claim 5, wherein the assessment condition is selected from the group consisting of a technology assessment, a market assessment, product analysis, a timely analysis, a regional economy assessment, a national policy assessment, and a customers SWOT analysis.

7. The method for semiconductor market development and resource management of claim 1, wherein drafting the interaction strategy of the client further comprises:
assessing the client to be a potential co-operative target or an observation target;
establishing a co-operative consultation and performing a negotiation with the client if the client is the potential co-operative target, performing the co-operative consultation and putting a negotiated result into the assessment condition if the negotiation is successful, ending the co-operative consultation and closing the client's data if the negotiation fails; and
determining whether the client is continuously observed or not if the client is the observation target, setting a time to review if yes; ending the co-operative consultation and closing the client's data if no.

8. The method for semiconductor market development and resource management of claim 6, wherein in performing the negotiation, a file of the negotiated data is established and put into the assessment condition to provide a reference whether the negotiation is successful or fails.
